(19) United States
(12) Patent Application Publication
(10) Pub. No.: US 2007/0039801 A1
(43) Pub. Date: Feb. 22, 2007

(54) Method and apparatus for protecting vending machine bill validator storage container

(75) Inventors: Calin V. Roatis, Long Grove, IL (US); Richard Paeth, St. Charles, IL (US); Catalin Captarencu, Wheeling, IL (US); Gary L. Myers, Monee, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: TriTeq Lock and Security, L.L.C., Elk Grove, IL (US)

(21) Appl. No.: 11/207,663

(22) Filed: Aug. 18, 2005

(51) Int. Cl. G07F 9/10

(52) U.S. Cl. 194/350

(57) ABSTRACT

A protective cover for the inner door mounted bill validator bill container of a vending machine or the like has a body including a back wall and four side walls perpendicular to the back wall and the cover is removably attachable to the inner end of a bill validator. A cable affixed to the cover attaches to a portion of the door so as to dangle the cover when it is removed from the bill validator. The cover is preferably made from heavy gauge formed steel.

### RELATED APPLICATIONS

This application is related to U.S. Des. application Ser. No.______, filed______, herein incorporated reference.

### FIELD OF THE INVENTION

The present invention relates to the security of a vending machine bill validator collections box and, in particular, to methods and devices for reducing loss due to theft and vandalism to such vending machine bill validators.

### FEDERALLY SPONSORED RESEARCH OR DEVELOPMENT

None.

### BACKGROUND OF THE INVENTION

The vending industry has been besieged with an ongoing issue of vandalism and break-ins. Vandalism and break-ins result in the loss of currency stored in the machines, costs for fixing the machines, and sales losses while the machines are inoperable due to damage.

One common style of vending machine in use over the years generally includes a door that is hinged at one side of a machine cabinet.

There are many security devices in the marketplace today that have incrementally improved security of specific areas of the vending column. These devices are designed to thwart attempts to gain access to the vending machines through external attacks. An external attack is being defined as a method using any other device other than what was intended to gain access to the inside of the vending machine. Examples of this type of attack are: prying the door with a crowbar, drilling or sawing through door lock and latch components, hammering in vulnerable panels and attached equipment such as the dollar bill validator and the product select buttons of the vending machine. These attacks are typically focused on the column area of the vending machine because the money and the locking system are housed inside the column.

The unique invention disclosed herein provides a solution for a type of common external vending machine vandalism attack, which is directed at partially prying open the door at the opening side of the door and accessing the stored bills in the bill validator storage box.

### SUMMARY OF INVENTION

The present invention is directed to a security device that can be integrated as part of the original equipment manufacture (OEM) of the vending machine or can be employed as an after-market enhancement to a vending machine. These OEM or after-market devices or vending machines, include a cabinet for containing product to be dispensed, along with a door for closing the cabinet. The door has upper and lower hinge pins about which the door pivots for opening and closing. A bill acceptor or exchanger is mounted on the door adjacent the opening side of the door.

According to one aspect of the invention, a protective cover is provided to be secured over the inner portion of the bill validator.

According to another aspect of the invention, the cover is provided with a cable that attaches to the door. The cable holds the cover to prevent closing the door unless the cover is in place.

Other embodiments, systems, methods, features, and advantages of the present invention will be, or will become, apparent to one having ordinary skill in the art upon examination of the following drawings and detailed description. It is intended that all such additional systems, methods, features, and advantages included within this description be within the scope of the present invention, and be protected by the accompanying claims.

### DESCRIPTION OF THE DRAWINGS

The invention may be better understood with reference to the following drawings. The components in the drawings are not necessarily to scale, emphasis instead being placed upon illustrating the principles of the invention. In the drawings, like reference numerals designate corresponding parts throughout the several views.

FIG. 1 is a rear perspective view of a vending machine inner bill validator protective cover for attachment thereto in accordance with the present invention;

FIG. 2 is an inside perspective view of the vending machine bill validator protective cover of FIG. 1;

FIG. 3 is a rear plan view of the cover of FIG. 1;

FIG. 4 is a front inside plan view of the cover;

FIG. 5 is a left side plan view thereof;

FIG. 6 is a right side plan view thereof;

FIG. 7 is a top view thereof;

FIG. 8 is a bottom view thereof;

FIG. 9 is a plan view of the cover in place on a bill validator carried by a machine door;

FIG. 10 is a partial perspective showing the cover suspended by the cable; and

FIG. 11 is a top plan view of a door and fragmentary portion of its machine cabinet with the cover on the inner side of the bill validator; and

FIG. 12 is an exploded perspective view of a bill validator and the cover.

### DESCRIPTION OF DETAILED EMBODIMENTS

The following descriptions of detailed embodiments are for exemplifying the principles and advantages of the inventions claimed herein. They are not to be taken in any way as limitations on the scope of the inventions.

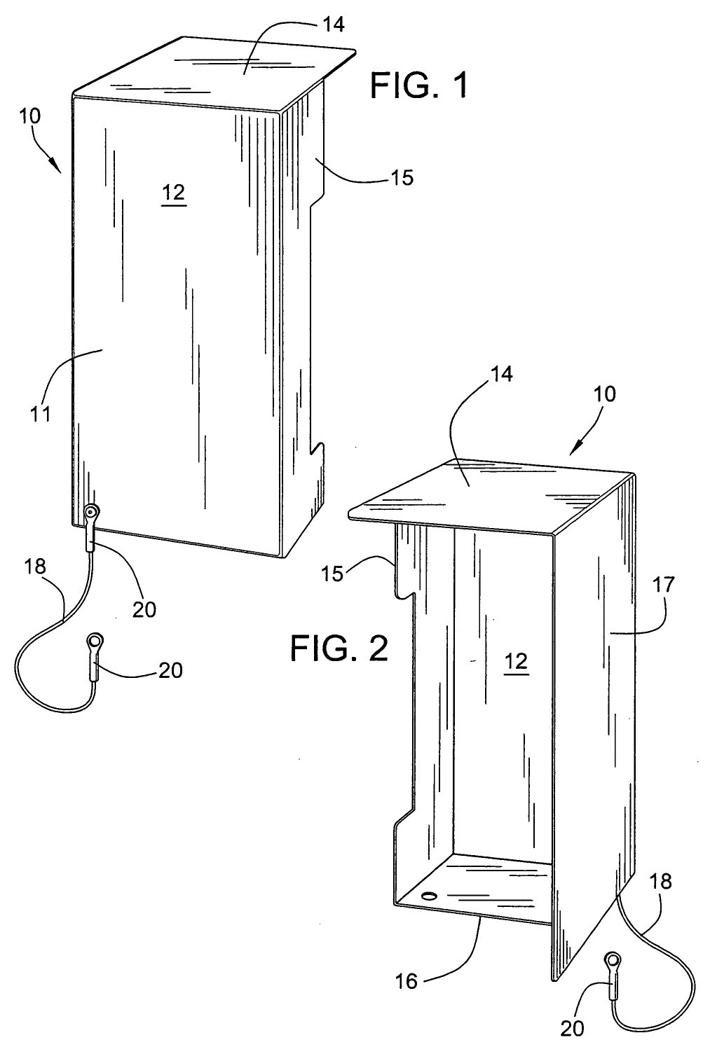

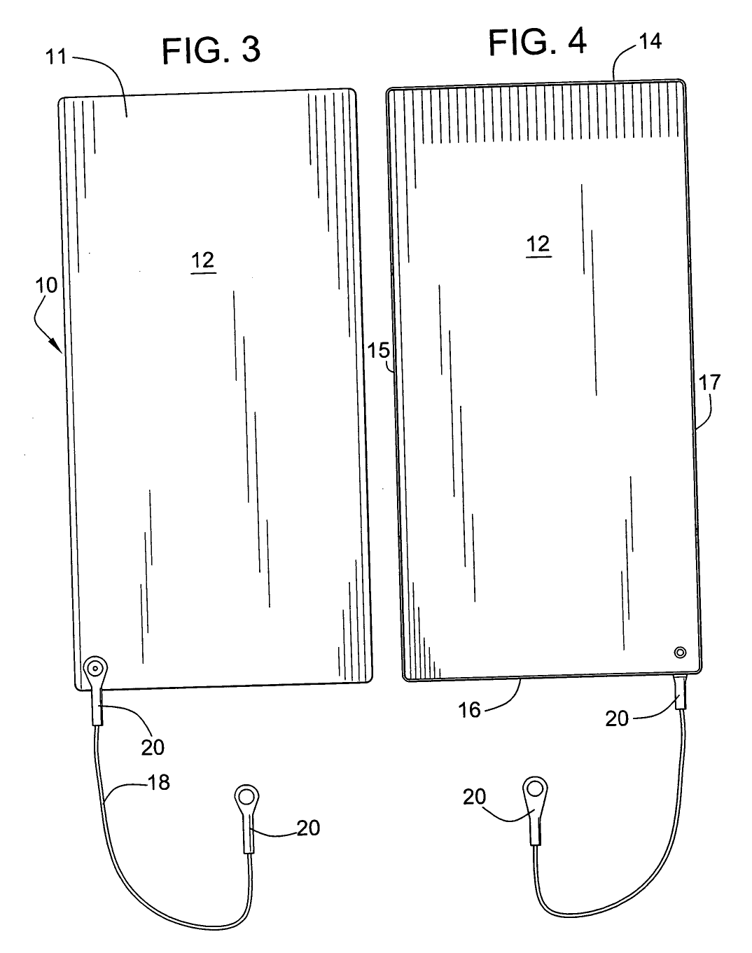

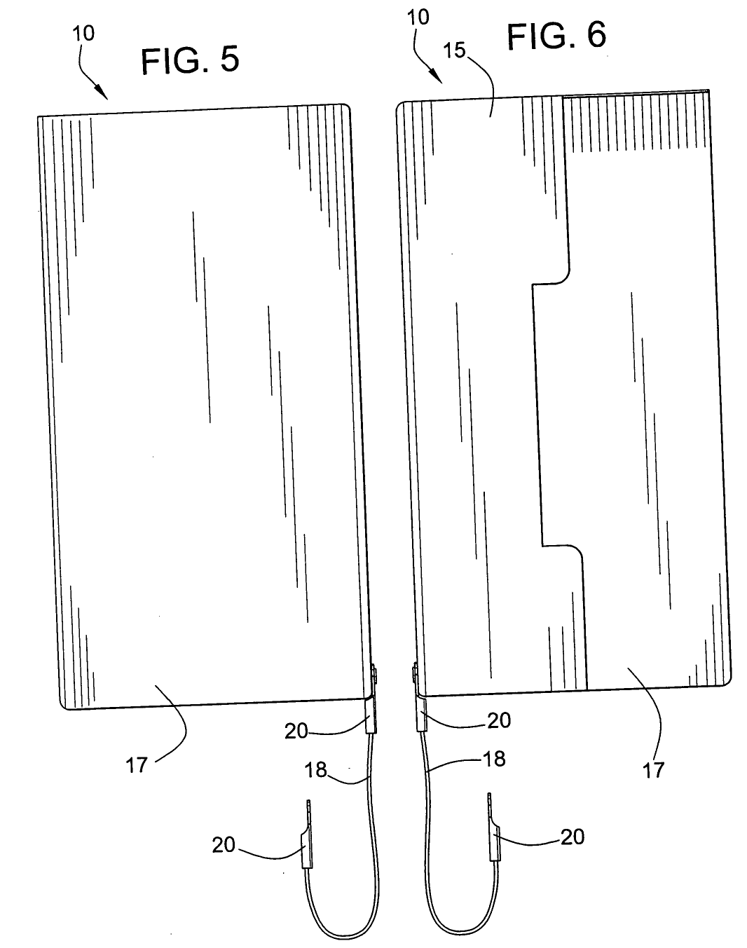

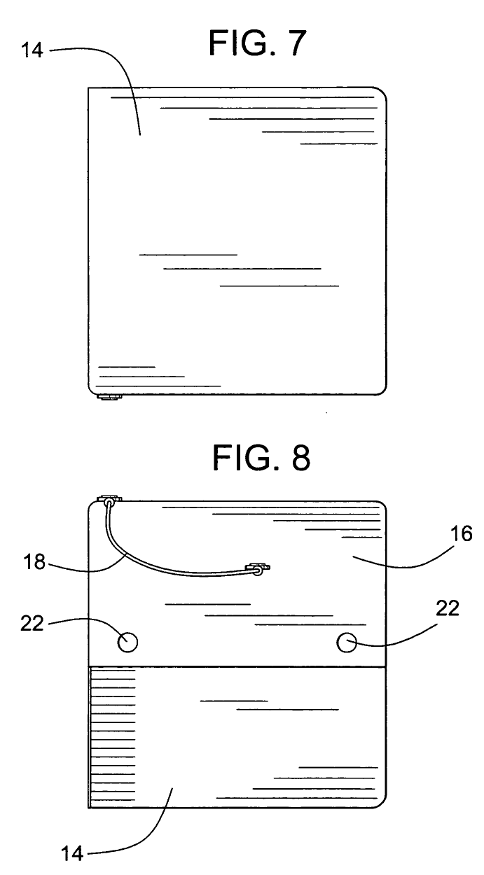

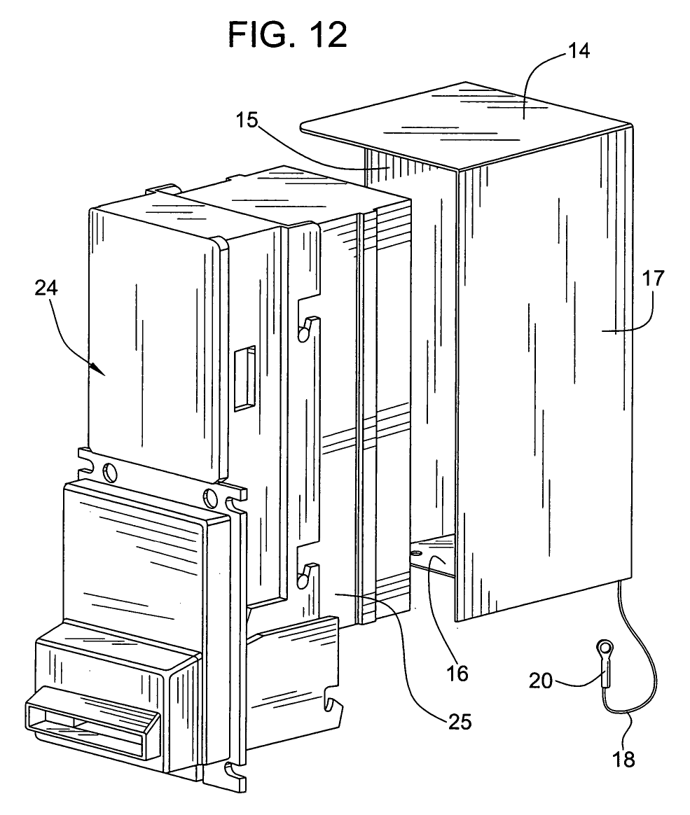

As shown in FIGS. 1-8, a cover generally indicated at 10, is provided to removeably attached over the inner portion of conventional dollar bill validator 24, (FIG. 12) typically used on vending machines. The cover 10, preferably includes a body formed from heavy gauge steel with a back 12, sides 14-17 perpendicular to the back to define the cover, and a cable 18, with swagged-on fittings 20. The sides are preferably bent over from a single sheet and welded at the corners. Two of the sides 14-17, may be straight walls and the other two sides 15 and 16, are shaped to conform to components of the bill validator 24 module. The side 16 may have predrilled holes 22 to receive fasteners for attaching and removing the cover. However, the bottom side 16 is optional and we prefer to leave it out.

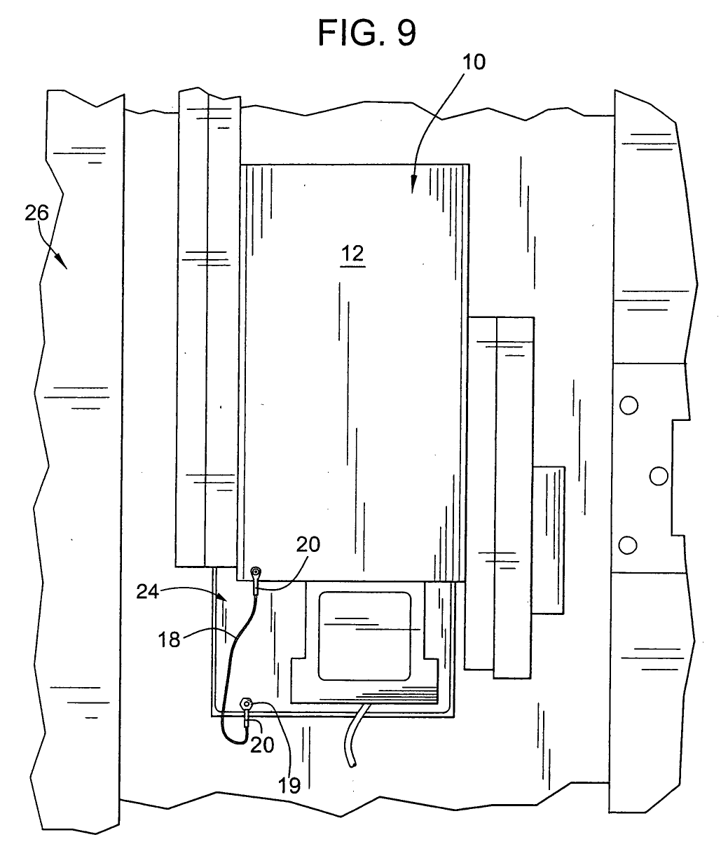

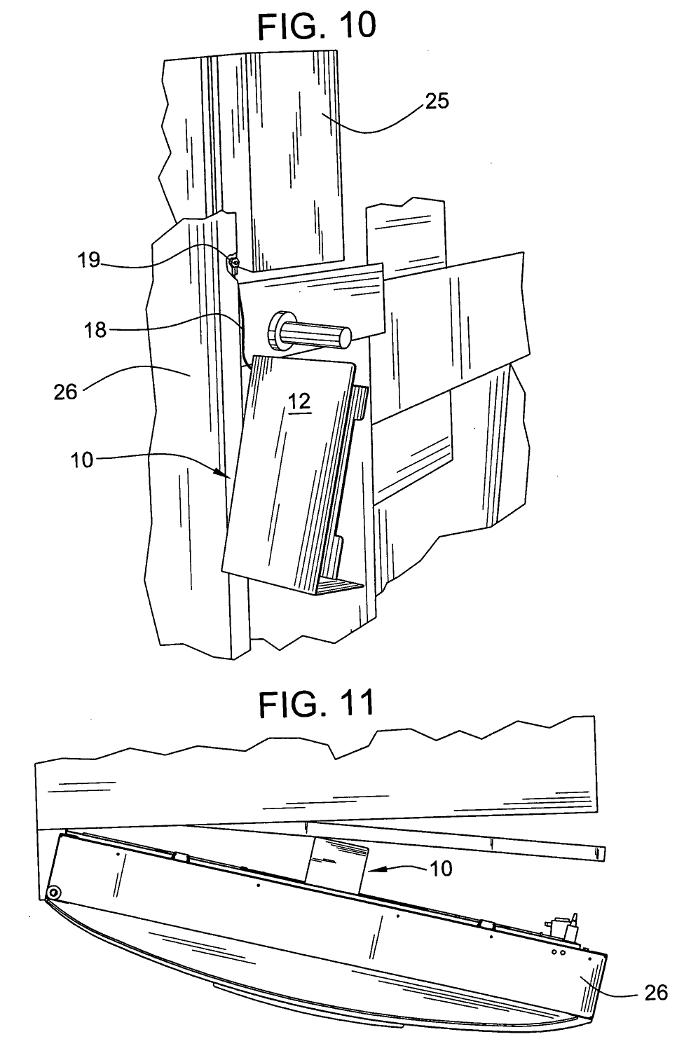

In accordance with the present invention cover 10 can be affixed over the bill holder box 25, of the validator 24 as best shown on FIGS. 9 and 11. The cable 18 free end fitting is attached to one of the fasteners 19 on the validator until FIG. 9. Thus, when the cover is released by an authorized service person or collection person, the cover 10 dangles in place to preclude closing and locking the vending machine door 26 unless the cover 10 is put back in place to protect the bill container or box 25.

In operation, aside from the cable 18 dangle feature to require an authorized person to replace the cover 10 after emptying the bill holder, it might also serve as notification that the door has been opened and cover removed regardless of whether by authorized personnel or a vandal. Vandals have pried vending machine doors enough to form an opening gap that without the protective cover 10 of the present invention, access may be had to the validator bill container. Even with a small gap the vandals have used tongs to remove the bills and the present cover 10 protects against such action.

It should be emphasized that the above-described embodiment of the present invention, particularly, any “preferred” embodiments, are possible examples of implementations merely set forth for a clear understanding of the principles of the invention. Many variations and modification may be made to the above-described embodiment(s) of the invention without substantially departing from the spirit and principles of the invention. All such modifications are intended to be included herein within the scope of this disclosure and the present invention, and protected by the following claims.

1. A method of protecting against accessing an inner door mounted bill validator bill container of a bill accepting machine comprising; providing a cover adapted to fit over the inner end of the bill validator; providing a cable means having one end attached to the cover, attaching the other end of the cable means to a portion of the door or a portion of a structure fastened to the door, and placing the cover over the inner end of the bill validator.

2. A method as claimed in claim 1, wherein said cover is fastened to the inner end of the bill validator.

3. A method as claimed in claim 8, wherein said cable means other end is attached to the bill receiving portion.

4. A method as claimed in claim 1, wherein said cover is made from formed sheet steel.

5. A protective inner cover for the inner end of a door mounted bill validator of a bill accepting machine comprising; a body having a back side, and three walls disposed perpendicular to the back side that define a cover surrounding at least the access to a bill holder of said bill validator, cable means attached at a first end to the body, and a second end of the cable having attaching means adapted to be affixed to a portion of the inside of the door or a portion of a structure fastened to the door.

6. A protective inner cover as claimed in claim 5, wherein said cover is formed from sheet steel having a heavier gauge than a material forming the bill holder.

7. A protective cover as claimed in claim 5, wherein said cover has fastening means for attaching the cover to the bill validator.

8. A method as claimed in claim 1, wherein the bill validator includes the bill holder and a bill receiving portion, wherein the bill holder is removably coupled to the bill receiving portion and the bill receiving portion is fastened to the door, and wherein the bill receiving portion receives and conveys bills to the bill holder.

9. A method as claimed in claim 1, wherein the bill accepting machine is a vending machine.

10. A method as claimed in claim 1, wherein said cover is removable from the inner end of the bill validator.

11. A method as claimed in claim 1, wherein before the cover is placed over the inner end of the bill validator, the cover hangs and prevents the door from closing.

12. A protective cover as claimed in claim 5, wherein the bill accepting machine is a vending machine.

13. A protective cover as claimed in claim 5, wherein the cover has a size that prevents the door from closing when the cover is not surrounding the access to the bill holder of said bill validator.
